(19) United States
(12) Patent Application Publication
(10) Pub. No.: US 2013/0212177 A1
(43) Pub. Date: Aug. 15, 2013

(54) Method and System for Generating a Social Commerce and Marketing Site

(71) Applicant: Aaron Friedman, Clementon, NJ (US)

(72) Inventor: Aaron Friedman, Clementon, NJ (US)

(73) Assignee: Fanpage Toolkit, LLC, Somerdale, NJ (US)

(21) Appl. No.: 13/568,105

(22) Filed: Aug. 6, 2012

Related U.S. Application Data
(60) Provisional application No. 61/515,657, filed on Aug. 5, 2011.

(51) Int. Cl. H04L 29/08

(52) U.S. Cl. CPC H04L 67/22
USPC 709/204

(57) ABSTRACT

A platform for enabling a user to generate a customized site within the social network environment. The platform may provide a user with a series of tools and/or APIs that allow a user to generate, modify, analyze, or promote a customized site within the social network environment. For example, a user may use the platform to generate a social commerce site located within the social network environment, such that social network users may make and complete purchases without leaving the social network environment.

### CROSS-REFERENCE TO RELATED APPLICATIONS

This application claims the benefit of priority under 35 U.S.C. §119(e) to U.S. Provisional Application No. 61/515,657, entitled, “Method and System for Generating a Social Commerce Site,” the entire disclosure of which is incorporated herein by reference.

### BACKGROUND OF THE INVENTION

1. Field of the Invention

The invention relates to the field of Internet commerce, and particularly to the field of conducting commerce and other tasks through and in a social network

2. Description of Related Art

Social network environments allow users with common interests to connect with one another. These social network environments, such as Facebook, Google+, Linkedin, Foursquare, Twitter, Pinterest and Myspace as well as others, for example, foster relationships between their users, thereby offering a higher level of affiliation and trust than other online media through which users can interact with each other.

Understanding the importance of connecting with users of the social network environment, companies have sought to increase the social media presence of their brands and products. For example, companies have attempted to encourage respondents who rate products and services highly to recommend brands to their online friends and “like” the company across various social network environments. Additionally, companies have sought to create social commerce sites within a social network environment that enable users to make purchases within the social network environment.

However, such social commerce sites to date often cannot complete a purchase within the social network environment due to an inability to integrate an electronic shopping cart within the social network environment. Additionally, these social commerce sites do not provide and integrate analytic data to indicate potential customers or leads to a company.

Therefore, there is a need in the art to assist users who wish to conduct business through and in a social network platform by creating interactive sites that improve on current networking environment but which is capable of leverage other social network sites and preferably also being designed, manipulated and otherwise analyzed and operated by a user outside of the social network environment.

### BRIEF SUMMARY OF THE INVENTION

Disclosed are systems and methods for generating a customized site, such as a social commerce site, within a social network environment.

A customized site may be generated using a template selection and site content provided by a user. For example, social networking site information may be retrieved from a social network environment. The social networking site information may define the appearance of the site within the social network environment. A template selection and site content may be received from a user. The template may define customizations to be made to the site. The customized site may then be generated using the template selection and the site content. Additionally, the customized site may be published to the social network environment.

A social commerce site capable of using a payment service within the social environment may be generated. This may be done, for example, to enable social network users to purchase an item without leaving the social network environment. To generate the social commerce site, a template selection may be received from a seller. The template may define a framework for the social commerce site. Site content may be received from a seller. The site content may include information regarding a product. Payment credentials may be received from the user. A social commerce site capable of using a payment service within the social network environment may then be generated to enable a social network user to purchase an item without leaving the social network environment. The social commerce site may be modified in accordance with the template and the site content. The social commerce site may also be published to the social network environment.

Analytic data related to a site within the social network environment may be generated and provided to a user. The analytic data may indicate interactions between social network user and the site. The analytic data may include a prospective lead. To generate the analytic data, an identity of a site within the social network environment may be received. Social network data related to the site may be retrieved from the social network. Analytic data may then be generated from the retrieved social network data and provided to a user.

Prospective leads, such as potential customers, may be identified such that a user may transmit a message to the prospective lead. The message may be generated externally from and to the social network environment and/or internally within the social network environment. To generate the message, social network data related to a site may be retrieved from within the social network environment. A prospective lead may be determined from the social network data. Message content may be received from a user. The message may be generated in accordance with message content received from a user of the social network and may be capable of being delivered within the social network environment. Additionally, the message may be transmitted to the prospective lead via the social network environment.

Promotions may be transmitted to social network users to enable the social network users to purchase items from a social commerce site at a discount. This may be done, for example, by providing the social network users with a promotion code that is capable of being redeemed within the social network environment. To generate the promotion, social network data related to a site, such as a social commerce site, may be retrieved from the social network environment. A promotion code capable of being redeemed within the social network environment may be generated. Promotion content and a template may be received from a user. A promotion that includes the promotion code may then be generated, for example, by using the promotion code, the promotion content, and the template. The promotion may also be transmitted to a social network user. Examples of other possible promotions are described herein.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a block diagram of a representative computing device that may be used in connection with the embodiments described herein;

FIG. 2 illustrates an example embodiment of a system for generating a customized site within a social network environment;

FIG. 3 illustrates an example embodiment of a platform for generating a customized site within a social network environment;

FIG. 4 illustrates a method for providing analytic data for a site belonging to a social network environment;

FIGS. 5A and 5B each illustrates an example embodiment of analytic data;

FIG. 6 illustrates a method for generating a customized site within a social network environment;

FIGS. 7A and 7B each illustrates example embodiments of customized site templates;

FIG. 8 illustrates a method for messaging prospective leads within a social network environment;

FIG. 9 illustrates a method for generating promotions to be used for a site within a social network environment;

FIGS. 10A and 10B each illustrate an example embodiment of a promotion template;

FIG. 11 illustrates a method for generating a social commerce site within a social network environment;

FIGS. 12A and 12B each illustrate an example embodiment of a social commerce template.

FIGS. 13A, 13B and 13C each illustrate example embodiments of platforms for generating a customized site within a social network environment; and

FIG. 14 illustrates a further example embodiment of a method for generating a customized site within a social network environment; and

FIG. 15 illustrates a more preferred embodiment of the analytics application module from FIG. 13A.

### DETAILED DESCRIPTION OF THE INVENTION

The following illustrates preferred, but not limiting embodiments of methods and systems for creating sites within a social network environment for providing advantages and promoting and conducting commerce without having to leave the social network environment. Methods are provided and described herein for providing analytic data to site belonging to a social network environment, generating a customized site within a social network environment, messaging prospective leads within a social network environment, generating promotions to be used for a site within a social network environment and generating a social commerce site within a social network environment as well as associated systems capable of carrying out such methods.

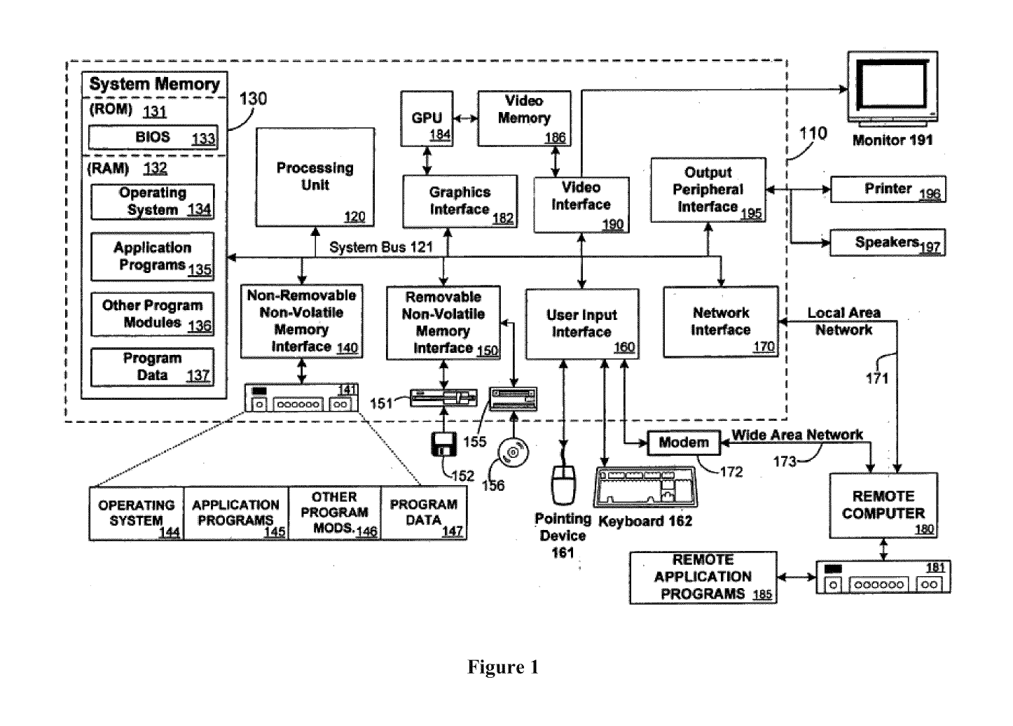

FIG. 1 and the following discussion are intended to provide a brief general description of a suitable computing device in connection with which the embodiments may be implemented. For example, any of the client and server computers or devices that may be used to implement the embodiments may take the form illustrated in FIG. 1. It should be understood, however, that handheld, cellular, tabular, portable and other computing devices and computing objects of all kinds are contemplated for use in connection with the embodiments. While a general purpose computer is described below, this is but one example, and the embodiments may be implemented within a client having network/bus interoperability and interaction. Thus, the embodiments may be implemented in an environment of networked hosted services in which very little or minimal client resources are implicated, e.g., a networked environment in which the client device serves merely as an interface to the network/bus.

Although not required, the embodiments may be included within an application or server software that operates in accordance with the embodiments. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, the embodiments may be practiced with other computer system configurations and protocols. Other well-known computing systems environments, and/or configurations that may be suitable for use with the embodiments include, but are not limited to, personal computers (PCs), server computers, hand-held devices, tablet devices, laptop devices, multi-processor systems, microprocessor-based systems, programmable consumer electronics, network PCs, and the like.

FIG. 1 illustrates an example of a suitable computing system environment 100 in which the embodiments may be implemented, although as made clear above, the computing system environment 100 is only one example of a suitable computing environment and is not intended to suggest any limitation as to the scope of use or functionality of the embodiments. Neither should the computing environment 100 be interpreted as having any dependency or requirement relating to any one or combination of components illustrated in the exemplary operating environment 100.

With reference to FIG. 1, an exemplary system for implementing the embodiments may include a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media may be any available media that may be accessed by computer 110 and includes both volatile and nonvolatile media, removable and non-removable media. By way of example, and not limitation, computer readable media may comprise computer storage media. Computer storage media include volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110.

The system memory 130 includes computer storage media in the form of volatile and/or nonvolatile memory such as read only memory (ROM) 131 and random-access memory (RAM) 132. A basic input/output system 133 (BIOS), containing the basic routines that help to transfer, information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example, FIG. 1 illustrates a hard disk drive 141 that reads from or writes to non-removable, nonvolatile magnetic media; a magnetic disk drive 151 that reads from or writes to a removable, nonvolatile magnetic disk 152; and an optical disk drive 155 that reads from or writes to a removable, nonvolatile optical disk 156, such as a CD-RW, DVD-RW or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146 and program data 147. Note that these components may either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

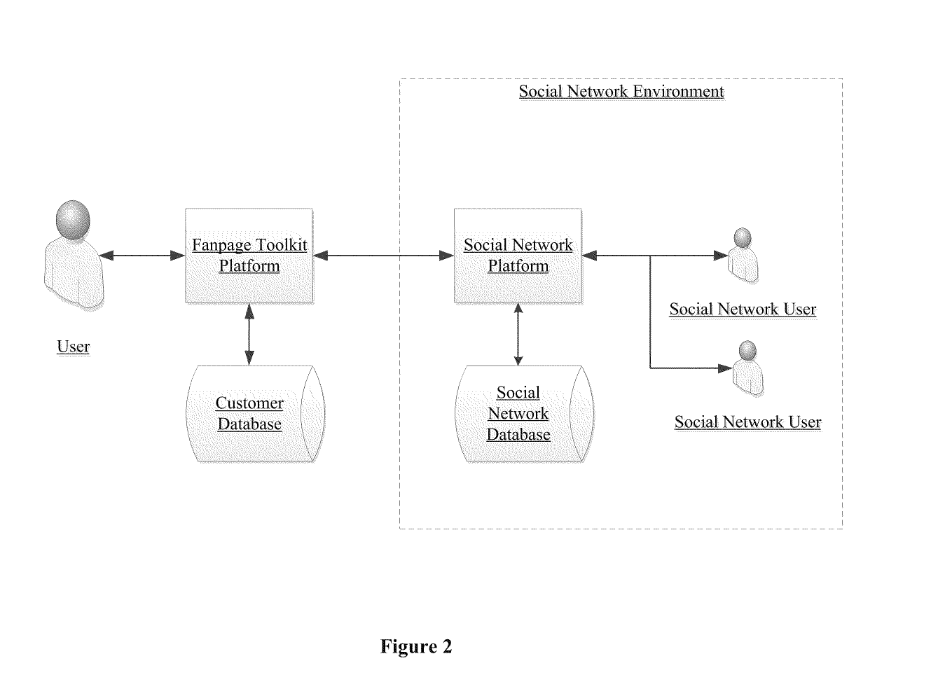

FIG. 2 illustrates an example embodiment of a system for generating a customized site within a social network environment. The customize site may be a social site page, a user profile page, a social commerce site, a social commerce and marketing site, a fan page, group page or the like. This system may enable the user to generate a customized site within the social network environment through an external platform. For example, a user may design a customized site using an external platform, such as the fanpage toolkit platform which is a preferred embodiment herein of a social commerce and/or marketing platform. It should be understood by one skilled in the art based on this disclosure that the terms fanpage toolkit platform and social commerce and/or marketing platform can be used interchangeably, with fanpage toolkit platform being one preferred embodiment used herein for the purposes of describing the invention in detail. Upon completing the design of the customized site, the user may instruct the external platform to generate the customized site. The external platform may then generate the customized site within the social network environment.

The social network environment may be an environment that focuses on the building and/or reflecting of social relations among people that may share interests. For example, the social network environment may be Facebook, Google+, MySpace, LinkedIn, Pinterest, FourSquare, Twitter, and the like. The social network environment may comprise any entity that provides social networking services, communication services, dating services, classmate interaction, and so forth. The social network environment may allow one or more social network users to communicate with one another. For example, a first social network user associated with a first device may communicate with a second social network user via the social network environment. Additionally, the social network environment may offer the social network user an opportunity to connect or reconnect with other social network users that attended, for example, the same university.

The social network environment may also include a social network platform and/or a social network database. The social network platform may provide a framework and/or an application program interface (API). The API may enable software developers to create applications that interact with the social network environment. For example, an application may use the social network platform to read from and write data to a site within the social network environment. Additionally, the social network platform may provide an interface that social network users may use to interact with the social network environment. The social network database may include information regarding social network users and the relation between the social network users. The information may include a representation of each social network user, social links for the social network users, personal information regarding the social network users, statistical information regarding usage of sites within the social network environment, or the like. Social network users and the fanpage toolkit platform may access the social network database via the social network platform.

The fanpage toolkit platform may provide a platform that may enable a user to generate a customized site within the social network environment. The fanpage toolkit platform is external to the social network environment, such that the fanpage toolkit platform is not part of the social network environment. As will be further explained below, the fanpage toolkit platform may provide a user with a series of tools and/or APIs that allow a user to generate, modify, analyze, or promote a customized site within the social network environment. For example, a user may use the fanpage toolkit platform to generate a social commerce site within the social network environment that allows social network users to make and complete purchases without leaving the social network environment.

The customer database may be used by the fanpage toolkit platform to determine customers and prospective leads for a user. The prospective leads may be potential customers. The customer database may include information regarding the customers of a user such as, phone numbers for the customers, addresses for the customers, email addresses for the customers, purchases made by the customers, or the like. The customer database may also include information regarding prospective leads, such as the identity of a product(s) viewed by the prospective lead, the name of the prospective lead, the email address of the prospective lead, the number of times a prospective lead viewed a product, the length of time a prospective lead viewed a product, the geographic location of the prospective lead, or the like. The customer database may also include analytic data generated by the fanpage toolkit platform and/or retrieved from the social network environment. For example, the fanpage toolkit platform may analyze social network user interaction with a site located within the social network environment, generate analytic data from that analysis, and save the analytic data within the customer database.

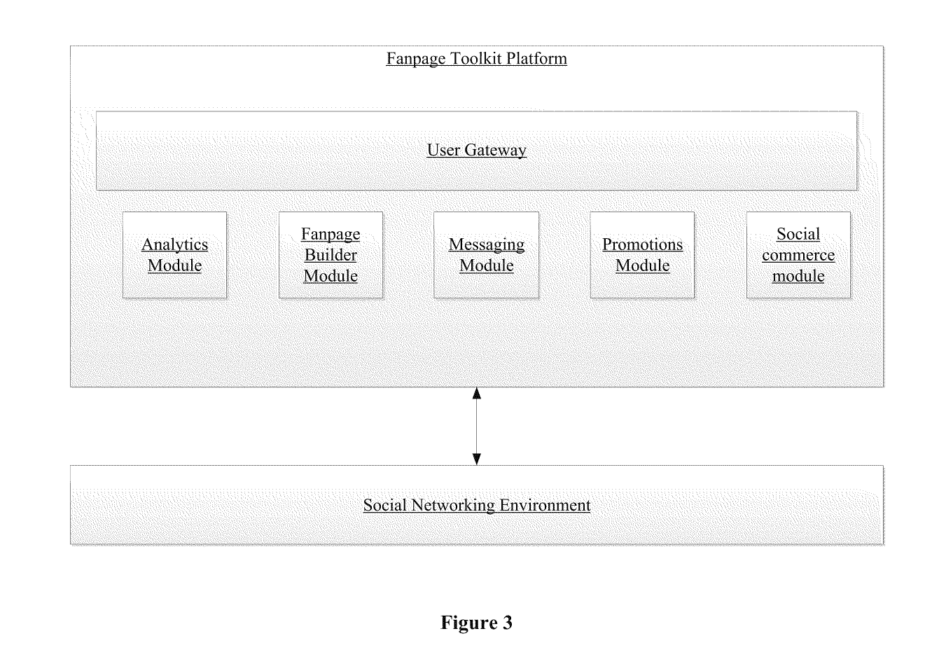

FIG. 3 illustrates an example embodiment of a platform for generating a customized site within a social network environment. A user may use the fanpage toolkit platform, for example, to generate a social commerce site located within the social network environment such that social network users may make and complete purchases without leaving the social network environment. As shown in FIG. 3, the fanpage toolkit social commerce and marketing platform can include a variety of modules including the analytics module, a page builder or fanpage builder module, a messaging module, a promotions module and a social commerce module.

The fanpage toolkit platform is external to the social network environment, such that the fanpage toolkit platform is not part of the social network environment. The fanpage toolkit platform may provide a user with a series of tools and/or APIs that allow a user to generate, modify, analyze, or promote a customized site within the social network environment. The tools may be implemented via one or more modules, such as an analytics module, a page builder module, a messaging module, a promotions module, a social commerce module, or the like.

The analytics module may generate analytic data from the customer database and/or the social network environment and may present the analytic data to a user. The analytic data may indicate interactions between the social network users and a site within the social network environment. The analytics data may include what is known as engagement data or statistics, wherein a fanpage toolkit user having a customized site can access data for each individual application to both view and export engagement data. Engagement data includes all data generated by a visitor to the site when he or she engages one of the applications, including but not limited to, for example, filling out contact information forms, wants to know more about the business of the customized site or its products, enters sweepstakes, etc. The user of the fanpage toolkit platform having an account is able to view the engagement data in real time and/or export the data into a CSV or similarly appropriate file form from the analytic platform engagement statistics collected.

The analytic data may also include prospective leads. For example, in generating the analytic data, the analytic module may generate a list of social network users that have interacted with the site within the social network environment. The analytics module may compare the list of social network users to a customer database that includes information regarding customers of the user. Individuals within the list of social network users that are not in the customer database may then be identified as prospective leads. Additionally, the analytics module may provide a user with a graphical or table view of the analytic data, for example, to enable a user to view page views and user statistics such as likes, un-likes, current customers, prospective leads, or the like. Such data may also be viewed in real time and/or exported.

The analytics module may also manage prospective leads and customers through geo-mapping to allow a user to track and pinpoint the location of the prospective leads and customers. Additionally, the analytics module may synthesize conversations within the social network environment using status tagging. All wall and timeline posts can be displayed to view, like and/or comment and then link back to each user's facebook profile.

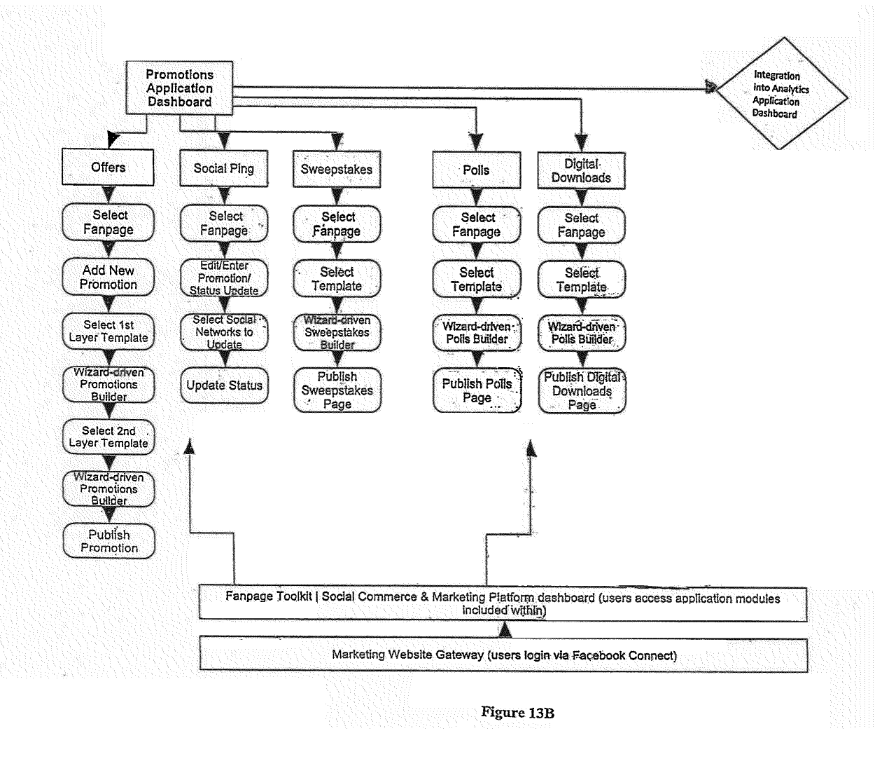

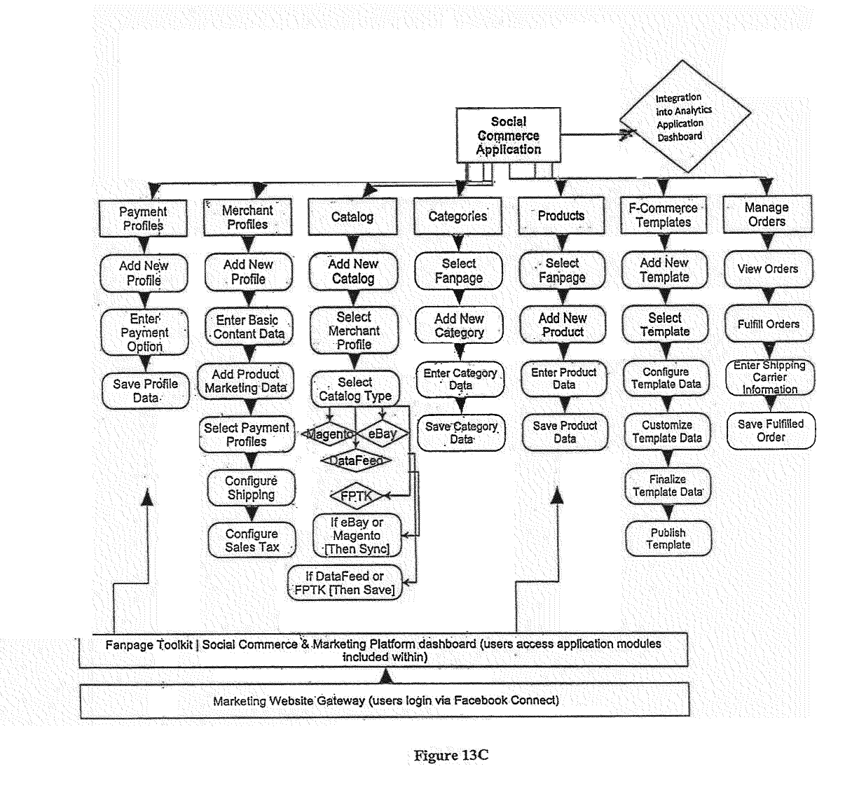

The fanpage builder module may generate a customized site within a social network environment. The page builder module, also referred herein in one embodiment as a fanpage builder module, may provide a user with a wizard-driven system that walks a user through the creation of a customized site. For example, the fanpage builder may receive a template selection from a user. The template may define customizations to be made to the site and/or a visual appearance for the site. The fanpage builder may also receive site content from the user. The site content may be used to fill content into the template and may include HTML code, text (as used herein, “text” may include embedded links, hyperlinks, objects, etc), objects, images, or the like. The fanpage builder may then generate the customized site using the template and the site content. Examples of such page builder options are shown in FIG. 13A for business pages, nonprofit pages, resume pages, and artist pages. In each case, the fanpage is selected, and a template can then be chosen. The wizard-driven fanpage builder than leads the user through the various options to create a page, and then publish the page. In the case of a nonprofit page, options are also provided for entering PayPal API credentials or similar payment information. In the case of the resume or career page, the LinkedIn API Profile can be synced as well. The artist option allows for specialty importation of video, image and music files in various forms for recording and other creative works.

The messaging module may post a message generated outside of a social network environment within the social network environment. This may be done, for example, to allow a user to post messages to social network users, customers and prospective leads. The messaging module may include manually entered email addresses as well as email addresses imported from the social network environment or any third party source such as LinkedIn Contacts, Paid Mailing Lists, Outlook Contact List, CRM programs, Plaxo Contact List, or the like. The messaging module may also track the messages sent to the social network users, customers, and prospective leads. The messaging module may provide a user with graphical or table view of number of messages sent from fanpage toolkit platform to the social network environment. The messages may include wall post messages or direct email messages.

The promotions module may generate promotions to be used for a site within a social network environment. This may be done, for example, to offer promotions and/or other offers, coupons to customers, prospective leads, or other social network users via the social network environment. The promotions module may also track and manage promotions. Additionally, the promotions module may utilize the social media network to publicize promotions. For example, the promotions module may send out a FANvite to invite customers and fans to participate in an event, program or promotion. The promotions module may also include a social media or social ping option in which a customized fanpage is selected, and then one can edit, enter promotion information and/or status update information, select various social networks to update and then update status.

Other promotional systems may be incorporated into the promotions model such as sweepstakes, polls and digital downloads, which may be transmitted to social network users to enable the social network users to participate in sweepstakes giveaway(s), participate in polling or being polled and to download digital goods or items, respectively. The purpose of these promotional systems is to have the social network users engage with the system, and submit user information for collection as a lead by the fanpage toolkit lead management system within the analytics module. The sweepstakes, poll and digital download options are wizard-driven to build and then publish the respective sweepstakes, poll or digital download option.

Each of the page builder, messaging and promotions modules interact with the analytics module providing engagement data for further analysis to the social commerce and marketing platform user when operating a customized site, such as through the fanpage toolkit platform. These modules and interaction are shown in FIGS. 13A-13C.

The social commerce module may generate a social commerce site within a social network environment. This may be done, for example, to generate asocial commerce site that social network users may use to make and complete purchases within the social network environment. To enable a social network environment user to purchase an item within the social network environment, the social commerce module may generate the social commerce site in such a way that the social commerce site may use a third party payment service, such as PayPal, authorized.net or other third party payment services. For example, when purchasing an item, a social network user may wish to provide payment through a third party payment service. The social commerce site may prompt the social network user for payment information and then communicate with the third party payment service while keeping the user within the social network environment.

The social commerce module may also allow users to manage orders from the user gateway. For example, users may be presented with a merchant profiles interface that displays the purchases made by customers, the status of those purchases, and the shipping status of purchased products.

The fanpage toolkit platform may also include a user gateway. The user gateway may be a website or application. The user gateway may provide a user with interface that allows the user to interact with the modules, tools, and APIs that are part of fanpage toolkit platform. For example, the user gateway may be a website that allows users to interact with the fanpage toolkit platform to generate a social commerce site within the social network environment such that social network users may make and complete purchases without leaving the social network environment.

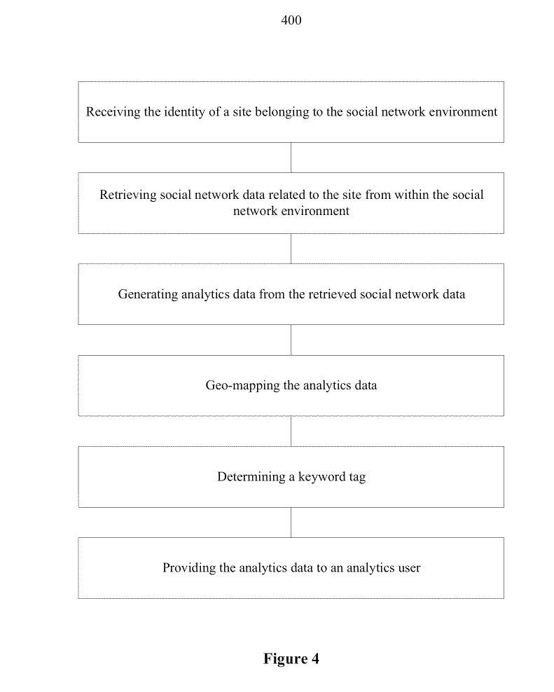

FIG. 4 illustrates a method 400 for providing analytic data for a site belonging to a social network environment. This may be done, for example, to generate analytic data from a customer database and/or a social network environment and may present the analytic data to a user.

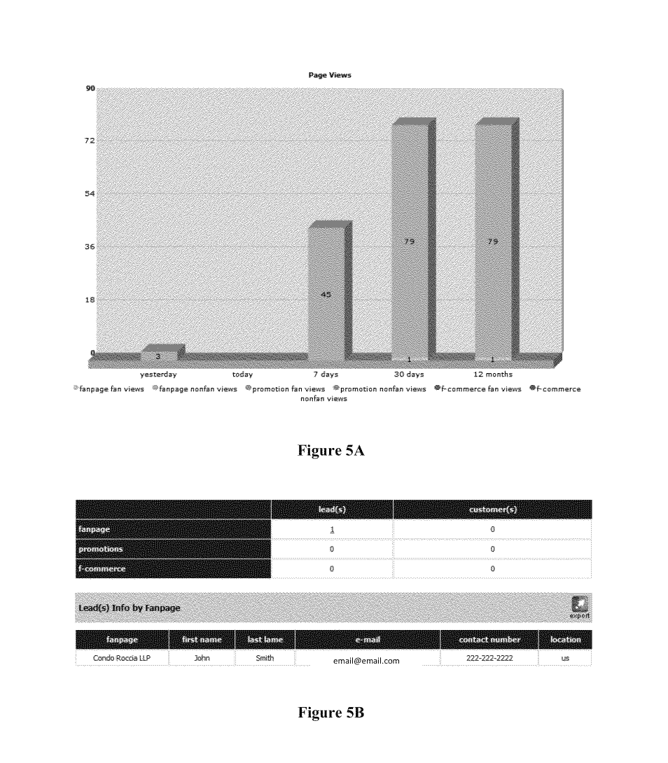

FIGS. 5A-B illustrate example embodiments of analytic data. As shown in FIGS. 5A-B, the analytic data may indicate social network user interactions with a site within the social network environment and may include customers and/or prospective leads. The analytic data may provide an analysis of social network data including wall posts, likes, un-likes, friend requests, visits, comments, email messages, or the like.

Referring again to FIG. 4, an identity of a site belonging to the social network environment may be received. For example, a user may provide the identity of the site. The site may be a social commerce site, a fanpage site, a user profile page, or the like. The site may belong to a social network environment, such as Facebook, Google+, MySpace, Pinterest, LinkedIn, Foursquare, Twitter, or the like.

Social network data related to the site may be retrieved from within the social network environment. The social network data may indicate social network user interactions with the site within the social network environment and may include information regarding customers and/or prospective leads. The social network data may comprise wall posts, likes, un-likes, friend requests, visits, comments, email messages, or the like.

Analytic data may be generated from the retrieved social network data. The analytic data may indicate interactions between social network users and the site. The analytic data may include a prospective lead. For example, the analytic data may indicate the number of times a social network user viewed a page, made a wall post, sent an email, made a purchase, or the like. The analytic data may include customer usage data, such as the number of customers that have used the site to make a purchase. The analytic data may include a profile link to a social network profile for a prospective lead. The analytic data will also include all engagement data as noted above.

In one example embodiment, determining analytic data for the site may comprise determining usage statistics and a profile link for each social network user that interacted with the site.

In another example embodiment, the analytic data may be generated to identify a prospective lead. To identify the prospective lead, a list of social network users that have interacted with the site may be generated from the retrieved social network data. The list of social network users may then be compared to a customer database. The customer database may include information regarding customers of a user. Customers and/or prospective leads may then be identified within the list of social network users.

In another example embodiment, known customers are removed from the list of social network users. The remaining social network users in the list of social network users may then be identified as prospective leads.

In another example embodiment, analytic data may be generated to identify a prospective lead when a social network user did not purchase a product. To identify the prospective lead, a product that was viewed by a social network user may be identified from the social network data. The social network data may then be analyzed to determine whether the product was purchased by the social network user. When the product was not purchased by the social network user, the social network user may be identified as the prospective lead.

In another example embodiment, analytic data may be generated to identify a prospective lead when a number of views exceeds a view threshold. To identify a prospective lead, the social network data may be analyzed to determine a product that a social network user viewed as well as the number of times the social network user viewed the product. When the number of times the social network user viewed the product exceeds a view threshold, the social network user may be identified as the prospective lead.

In another example embodiment, analytic data may be generated to identify a prospective lead when a view time exceeds a view threshold. To identify a prospective lead, the social network data may be analyzed to determine a product that as social network user viewed as well as a view time duration. The view time duration may indicate a length of time that the social network user viewed the product. When the view time duration exceeds a view time threshold, the social network user may be identified as the prospective lead.

In another example embodiment, analytic data may be generated to identify a social network user that placed a product in a shopping cart as a prospective lead. To identify a prospective lead, the social network data may be analyzed to determine a product that was placed in a shopping cart belonging to the site. The product may be identified in the shopping cart. The social network data may then be analyzed to determine the social network user that placed the product in the shopping cart. The social network user may then be identified as the prospective lead.

The analytic data may be geo-mapped. This may be done, for example, to allow a user to track and pinpoint the location of prospective leads and customers. To geo-map the analytic data, a geographic location may be determined for each social network user within the analytic data. The analytic data for each social network user may then be associated with the geographic location for each social network user.

A keyword tag may be determined by analyzing the retrieved social network data. This may be done to synthesize conversations within the social network environment using status tagging. Social network user conversations may be retrieved from the social network data. Words within the social network user conversations may then be ranked. Keyword tags based on the ranked words may be generated.

The analytic data may be provided to a user. In one embodiment, providing the analytic data to the user may comprise providing a graphical view of the analytic data. In another example embodiment, providing the analytic data to the user may comprise displaying a social network profile for the prospective lead or a customer.

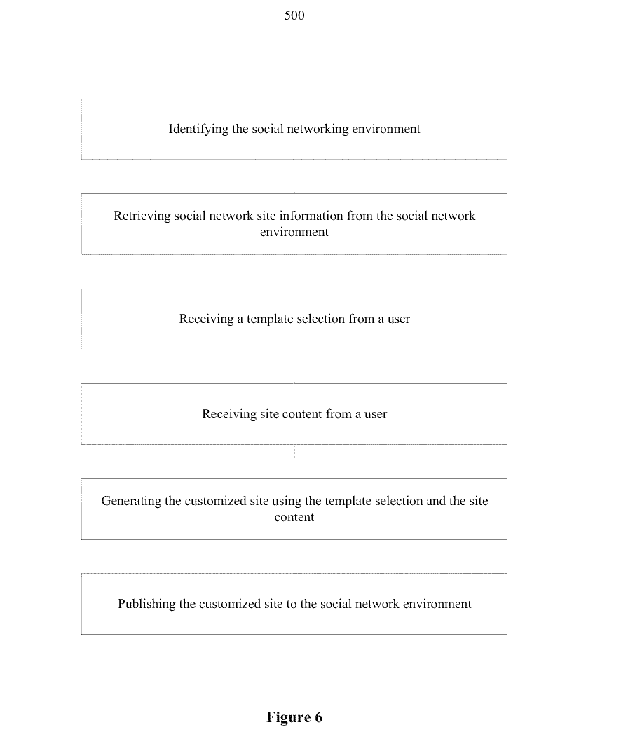

FIG. 6 illustrates a method 500 for generating a customized site within a social network environment. This may be done, for example, to provide a user with a wizard-driven system that will walk the user through the creation of a customized site.

In generating a customized site, an identity of a site belonging to the social network environment may be received. For example, a user may provide the identity of the site. The site may be a social commerce site, a fanpage site, a user profile page, or the like. The site may belong to a social network environment, such as Facebook, Google+, MySpace, Pinterest, LinkedIn, Foursquare, Twitter or the like.

Social network site information may be retrieved from the social network environment. The social network site information may define the appearance of the site within the social network environment.

In one example embodiment, the social network environment may be identified. One or more templates that are compatible with the social network environment may then be determined and may be presented to the user.

A template selection may be received from a user. The template may define customizations to be made to the site and/or a visual appearance for the site.

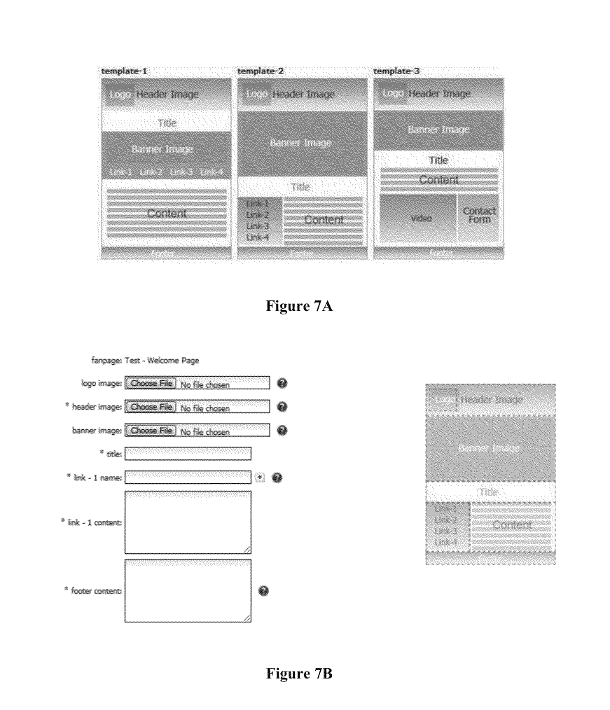

FIGS. 7A-B illustrate example embodiments of customized site templates. As shown in FIGS. 7A-B, the templates allow the user to customize and change the appearance, layout, color, style and font for a site.

Site content may be received from a user. The site content may comprise HTML code, text, images, or the like. The site content may be used to fill content into the template. For example, a template may include a contact form. A user may wish to provide a brief explanation of the contact form as well as instructions to fill out the contact form. Additionally, a user may wish to provide a title for the site that will display the contact form. By providing site content, the user may provide the title, the explanation of the contact form, and the instructions to fill out the contact form. The site content may then be used to complete the template by populating the template with the site content.

The customized site may be generated using the template and the site content. For example, the social networking site information may be manipulated according to the customizations and/or a visual appearance defined by the template. The site may then be filled with content taken from the site content. In one example embodiment, HTML code may be retrieved from the site content. The social network site information may then be manipulated according to the HTML code. In one example embodiment, the customized site is generated externally from the social network environment.

The customized site may be published to the social network environment, such that the customized site may be displayed and used-within the social network environment. In one example embodiment, publishing the site may comprise installing a social network application capable of executing within the social network environment and providing support for the customized site. The customized site may then be published by transmitting executable instructions to the social network application to publish the customized site.

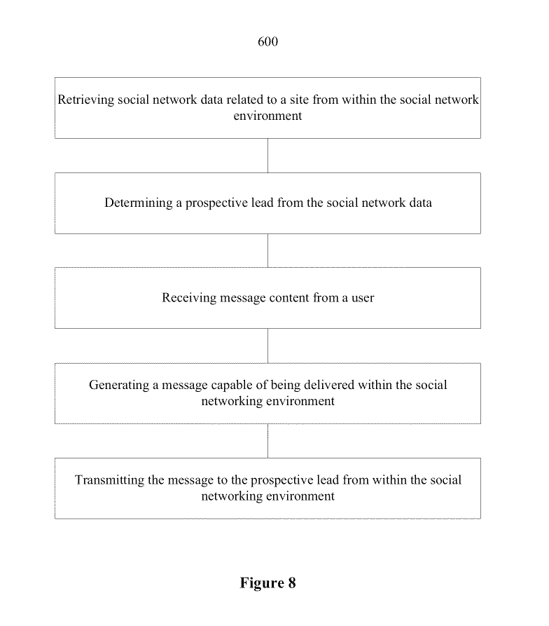

FIG. 8 illustrates a method 600 for messaging prospective leads within a social network environment. This may be done, for example, to post a message generated outside of a social network environment within the social network environment, such that social network users may receive the message via the social network environment.

Social network data may be retrieved from a site from within the social network environment. The social network environment may be an environment that focuses on the building and/or reflecting of social networks or social relations among people that may share interests and/or other activities. For example, the social network environment may be Facebook, Google+, MySpace, Pinterest, LinkedIn, Twitter, FourSquare, or the like. The social network data may indicate social network user interactions with the site within the social network environment and may include information regarding customers and/or prospective leads. The social network data may comprise wall posts, likes, un-likes, friend requests, visits, comments, email messages, social network user profiles, email addresses, phone or the like. The social network data may also identify a social network user capable of receiving a message. The site may be a social commerce site, a website, a fanpage site, or a user profile page.

Email address may be entered manually or imported from a third party source. The third party source may be a source such as LinkedIn Contacts, Paid Mailing Lists, Outlook Contact List, Plaxo Contact List, or the like. This may be done, for example, to enable a user to create an email message campaign that allows the user to transmit a message to social network users within the social network environment as well as individuals with email addresses outside the social network environment.

A customer may be determined from the social network data. For example, a list of social network users that have interacted with the site may be generated from the retrieved social network data. The list of social network users may then be compared to a customer database. The customer database may include information regarding customers of the user. Customers may then be identified within the list of social network users.

A prospective lead may be determined from the social network data. In one example embodiment, the prospective lead may be identified when a social network user did not purchase a product. For example, a product that was viewed by a social network user may be identified from the social network data. The social network data may then be analyzed to determine whether the product was purchased by the social network user. When the product was not purchased by the social network user, the social network user may be identified as the prospective lead.

In another example embodiment, the prospective lead may be identified when a number of views exceeds a view threshold. For example, the social network data may be analyzed to determine a product that a social network user viewed and the number of times the social network user viewed the product. When the number of times the social network user viewed the product exceeds a view threshold, the social network user may be identified as the prospective lead.

In another example embodiment, the prospective lead may be identified when a view time exceeds a view threshold. The social network data may be analyzed to determine a product that a social network user viewed as well as a view time duration. The view time duration may indicate a length of time that the social network user viewed the product When the view time duration exceeds a view time threshold, the social network user may be identified as the prospective lead.

In another example embodiment, the prospective lead may be identified when a social network user places a product in a shopping cart. The social network data may be analyzed to determine the product that was placed in a shopping cart that belongs to the site. The product may be identified. The social network data may then be analyzed to determine the social network user that placed the product in the shopping cart. The social network user may then be identified as the prospective lead.

A message selection may be received from the user. The message selection may indicate asocial network user that should receive the message. For example, the message selection may indicate that a prospective lead or a customer should receive the message.

Message content may be received from a user. The message content may comprise a picture, a video, a sound recording, a promotion, text, or the like. For example, the user may wish to send a message to customers. In creating the message, the user may generate. Message content such as the logo of the company, text, and a promotion that allows customers to buy an item at a discount. The message content may then be received from the user, which may then be used to generate a message.

A message capable of being posted within the social network environment may be generated in accordance with the received message content. The received message content may be analyzed to determine the visual appearance and content of the message. The message selection may be analyzed to determine the social network users that should receive the message. The social network environment that will be used to transmit the message may be determined. A message compatible with the social network environment may then be generated. In one example embodiment, a user may wish to send a message via multiple social network environments; to ensure compatibility with the multiple social network environments, multiple messages may be generated. For example, the user may wish to send a message to prospective leads via Facebook and Google+; however, a message generated for Google+ may not be compatible with Facebook. Accordingly, a compatible message may be generated for Google+ and a compatible message may be generated for Facebook.

The message may be posted to the social network environment. Additionally, the messages sent to the social network users, customers, or prospective leads may be tracked. Users may also be provided with a graphical or table view of the number of messages sent from the fanpage toolkit platform to the social network environment. The messages may include wall post messages or direct email messages.

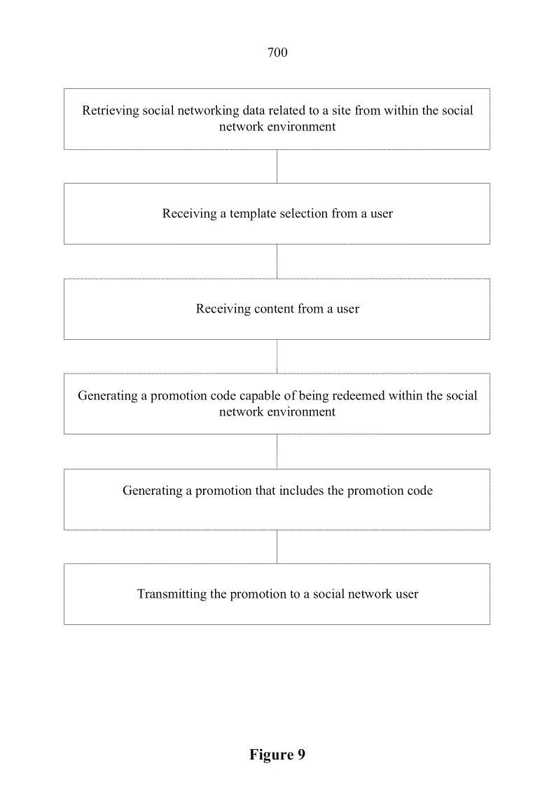

FIG. 9 illustrates a method 700 for generating promotions to be used for a site within a social network environment. This may be done, for example, to offer promotions and/or coupons to customers, prospective leads, or other social network users via the social network environment. The promotions may be tracked and managed. Additionally, the social media network may be leveraged to publicize the promotions. For example, FANvites may be used to invite customers and fans to participate in an event, program or promotion.

Social network data related to the site may be retrieved from within the social network environment. The social network data may indicate social network user interactions with the site within the social network environment and may include information regarding customers and/or prospective leads. The social network data may comprise wall posts, likes, un-likes, friend requests, visits, comments, email messages, or the like.

A template selection may be received from a user. The template may define customizations to be made to the promotion and/or a visual appearance for the promotion. For example, the template selection may define a framework for the promotion that may later be filled with content provided by the user.

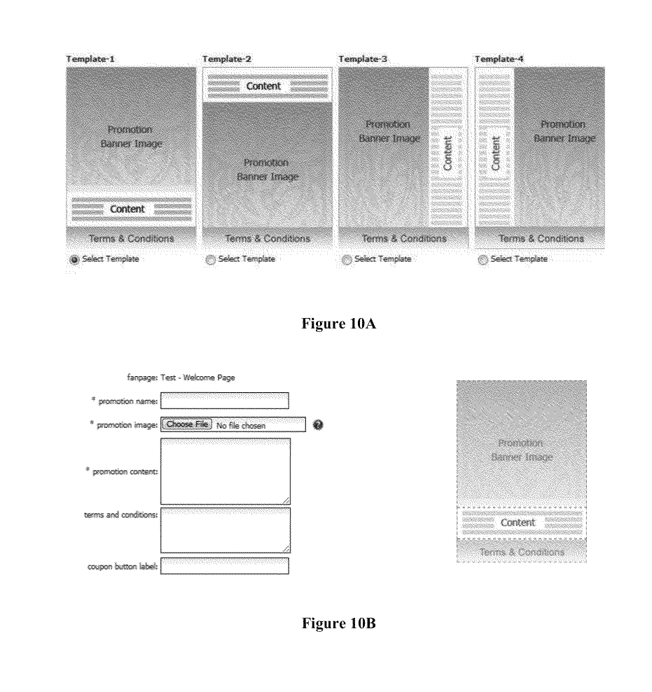

FIGS. 10A-B illustrate example embodiments of promotion templates. As shown in FIGS. 10A-B, the templates allow the user to customize and change the appearance, layout, color, style and font for a promotion.

Promotion content may be received from a user. The promotion content may comprise HTML code, text, images, or the like. The promotion content may be used to fill content into the template. For example, a template may include require promotion content such as, a banner image, a message, and terms and conditions. The message may be written by a user to explain the promotion. The banner image may be provided by the user and may be a logo, a product image, an advertisement, or the like. The terms and conditions may also be provided by the user and may be used to explain the terms and the conditions of the promotion. The promotion content may then be used to complete the template by populating the template with the promotion content.

A promotion code capable of being redeemed within the social network environment may be generated. The promotion code may be an alphanumeric code, a numeric code, a quick response code, or a bar code. The promotion code may enable a social network user to purchase a product from a social commerce site at a discount. For example, a social network user may receive the promotion code and may use the code to purchase a product within the social network environment at discount.

A promotion may be generated that includes the promotion code. This may be done, for example, to allow social network users that receive the promotion to use the promotion code to receive a discount when purchasing an item from a social commerce site. In generating the promotion, the promotion may be generated according to the appearance defined by the template. The promotion may be populated with promotion content. For example, the promotion content may be used to populate the template with the promotion content. The promotion may then be populated with the promotion code. For example, an alphanumeric code that may be redeemed by a social network user for a twenty percent discount may be included within the promotion.

In one example embodiment, HTML code may be retrieved from the promotion content. The appearance of the promotion may then be manipulated according to the HTML code.

The promotion may be transmitted to the social network environment. This may be done, for example, to deliver the promotion to social network users, which may include prospective leads and/or customers. In one example embodiment, transmitting the promotion to the social network environment may comprise displaying the promotion to the social network user within the social network environment. In another example embodiment, transmitting the promotion to the social to the social network environment may comprise transmitting an invitation from within the social network environment to social network users that invites the social network users to interact with the site.

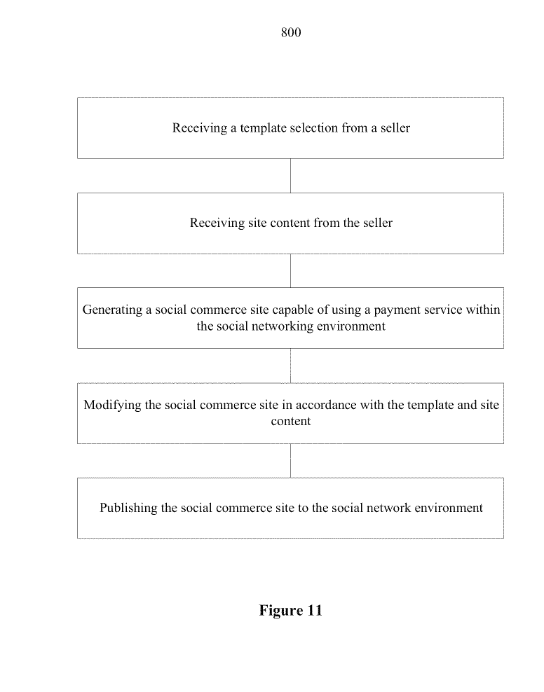

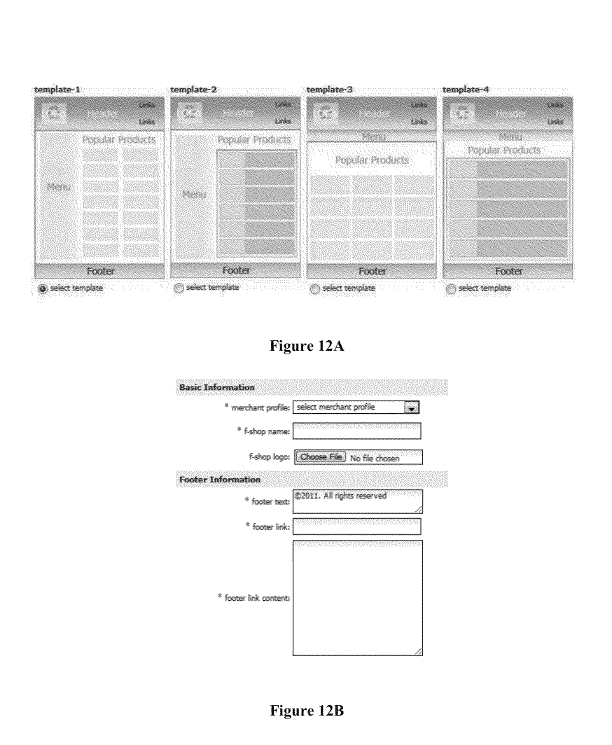

FIG. 11 illustrates a method 800 for generating a social commerce site within a social network environment. This may be done, for example, to generate a social commerce site that social network users may use to make and complete purchases without leaving the social network environment. For example, when purchasing an item, a social network user may wish to provide payment through a third party payment service. The social commerce site may prompt the social network user for payment information, communicate with the third party payment service, and complete the purchase while keeping the user within the social network environment.

An identity of a site belonging to the social network environment may be received. For example, a user, such as a seller, may provide the identity of the site. The seller may be an individual that wishes to sell products through the social network environment. The site may be a social, commerce site, a fanpage site, a user profile page, or the like. The site may belong to a social network environment, such as Facebook, Google+, MySpace, Pinterest, LinkedIn, Foursquare, Twitter and the like.

Social network site information may be retrieved from the social network environment. The social network site information may define the appearance of the site within the social network environment.

In one example embodiment, the social network environment may be identified. One or more templates that are compatible with the social network environment may be determined. The one or more compatible templates may then be presented to the user.

A template selection may be received from a user. The template may define customizations to be made to the site and/or a visual appearance for the site.

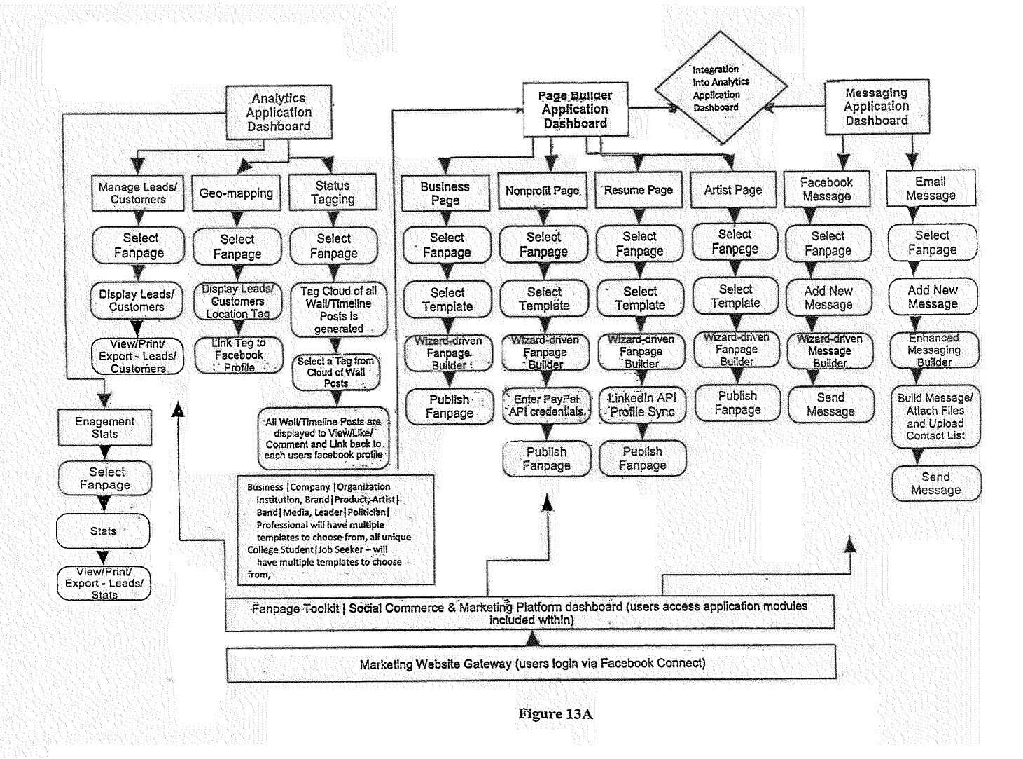

FIGS. 12A-B illustrate example embodiments of social commerce templates. As shown in FIGS. 12A-B, the templates allow the user to customize and change the appearance, layout, color, style and font for a site.

Referring again to FIG. 11, site content may be received from a user, such as a seller. The site content may comprise HTML code, text, images, or the like. The site content may be used to fill content into the template. For example, a template may include a contact form. The user may wish to provide a brief explanation of the contact form as well as instructions to fill out the contact form. Additionally, the user may wish to provide a title for the site that will display the contact form. By providing site content, the user may provide the title, the explanation of the contact form, and the instructions to fill out the contact form. The site content may then be used to complete the template by populating the template with the site content.

A social commerce site capable of using a payment service within the social network environment may be generated. This may be done, for example, to allow a social network user to purchase an item from a social commerce site and pay for the item without leaving the social network environment. Allowing the social commerce site to use a payment service within the social networking may prevent forcing social network users to leave the social network environment in order to pay for a purchase through a third party website that is neither part of the social network environment, nor controlled by the seller. The payment service may be a service that allows payments and money transfers to be made through the internet such as PayPal, Authorized.net, Amazon checkout, Google checkout, Wirecard, or the like.

In one example embodiment, an electronic shopping cart that is able to access a payment service may be generated. To generate the electronic shopping cart, a payment service may be selected by a user. Credentials for the payment service may be received from a user. An electronic shopping cart compatible with the payment service may be generated using the credentials. The electronic shopping cart may then be associated with the social commerce site such that the electronic shopping cart is able to access the payment service using the credentials from within the social network environment.

In another example embodiment, an electronic shopping cart that is able to access a payment service via a payment service API may be generated. To generate the electronic shopping cart, the identity of a payment service may be received from a user. A payment service API compatible with the payment service identified may be determined. The payment service API may allow the site and/or programs associated with the site to interact with the shopping cart or the payment service. An electronic shopping cart to be used within the social network environment may then be generated. The electronic shopping cart may be connected to the payment service. The electronic shopping cart may use the payment service API to communicate with the payment service.

In another example embodiment, a social commerce site able to display and sell a product within a social network environment may be generated. A product selection may be received from a user. The product selection may indicate a product to be sold on the social commerce site. For example, the product selection may be a video game. A social commerce site able to display and sell the product may then be generated to, for example, display and sell the product to a social network user from within the social network environment.

The social commerce site may be modified using the template and the site content. For example, the social networking site information may be manipulated according to the customizations and/or a visual appearance defined by the template. The site may then be filled with content taken from the site content. In one example embodiment, HTML code may be retrieved from the site content. The social network site information may then be manipulated according to the HTML code. In one example embodiment, the customized site is generated externally from the social network environment.

The social commerce site may then be published to the social network environment, such that the customized site may be displayed and used within the social network environment. In one example embodiment, publishing a website may comprise installing a social network application capable of executing within the social network environment and providing support for the customized site. The customized site may then be published by transmitting executable instructions to the social network application to publish the customized site.

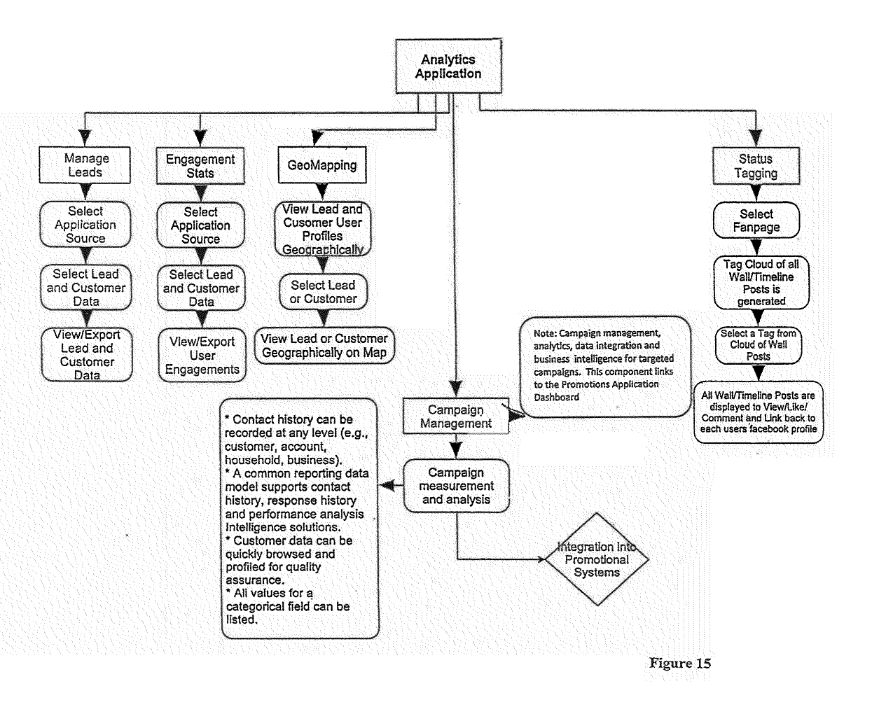

FIGS. 13A, 13B and 13C (as well as FIG. 15) illustrate example embodiments of a platform for generating a customized site within a social network environment. A user may use the fanpage toolkit platform, for example, to generate a social commerce site located within the social network environment such that social network users may make and complete purchases without leaving the social network environment.

The fanpage toolkit platform is external to the social network environment, such that the fanpage toolkit platform is not part of the social network environment. The fanpage toolkit platform may provide a user with a series of tools and/or APIs that allow a user to generate, modify, analyze, or promote a customized site within the social network environment. The tools may be implemented via one or more modules, such as an analytics module, a page builder module, a messaging module, a promotions module, a social commerce module, or the like. It would be understood by one skilled in the art based on this disclosure that various combinations of such modules within the platform can be created to provide unique platforms for various users according to their preferences.

The fanpage toolkit platform may include a marketing website gateway that may enable users to select a matching vertical for account setup. The verticals may define who the user is. A vertical may be a business, a company, an organization, an institution, a brand, a product, an artist, a band, a politician, a college student, a job seeker, or the like. For example, a small business wanting to create a social commerce site on Facebook may select a business vertical. The marketing website gateway may also allow users to choose subscription plans and select additional products that a user would like to add to their fanpage toolkit platform account.

The fanpage toolkit platform may also include a platform dashboard that may allow users to manage fanpage toolkit subscriptions and access the fanpage toolkit modules described with respect to FIG. 3. For example, the platform dashboard may include an analytics application dashboard, a page builder application dashboard, a messaging application dashboard, a promotions application dashboard, a social commerce application dashboard, or the like. Additionally, the platform dashboard may allow a user to synchronize and edit social network data between the platform accounts and a social network profile within the social network environment for the user.

The analytics application dashboard may provide a user with graphical or table view of analytic data of social network users within the social network environment. Using the analytics application dashboard, which also interacts with various other application dashboards such as the social commerce, promotions, page builder and/or messaging dashboards, a user may select a site from a pull-down menu to view analytic data for that specific site within the social network environment. For example, a user may be able to view page view and user statistics such as likes, un-likes current customers, prospective leads, or the like.

The analytics application dashboard may also allow a user to manage leads and/or customers. The analytics application dashboard may provide a user with a breakdown of social network user statistics of customers and leads from the social network environment, promotions, and social commerce activities. For example, a user may select a social network site from a pull-down menu to view lead data for that specific site. The user may then view social network profile data for prospective leads and current customers that funnel into the fanpage toolkit platform modules.

The analytics application dashboard may also allow a user to view geo-mapping data. Geo-mapping may allow a customer to track the location and mapping of prospective leads and current customers from a site selected from the social network environment. In one example embodiment, a map may be used to display the geo-mapping data such that a user may Zoom-in and zoom-out of the map and may select push pin to reveal analytic data and social network profile links for each user that interacts with the site.

The analytics application dashboard may also allow a user to view status tagging data. Status tagging may be a collection of keyword tags, generated by an algorithmic ranking system. For example, the algorithm may analyze social network user conversation via wall post and news feeds generated by the social network users.

The fanpage application dashboard may allow a user to generate a customized site with the social network environment. For example, the user may select a vertical and identify a site within the social network environment that the user wishes to customize. The fanpage page builder application dashboard may then use a wizard-driven builder to assist the user in customizing the site. The user may then select a template as described above. The user may fill content into the selected template, add appropriate images, add links for a business page, or the like. Additionally, the user may use HTML within content specific fields to customize the site. The user may then select portions of the visual appearance of the site that the user would like to modify. For example, the user may change the color, style, or font of the site. The user may then instruct the platform to publish the site to the social network environment.

The fanpage application dashboard may also allow a user to add an electronic shopping cart or a payment service to a site within the social networking environment. This may be done, for example, to enable a social network environment user to purchase an item without leaving the social network environment. The user may provide the fanpage application dashboard with credentials for a payment service. The fanpage application dashboard may then instruct the platform to generate a social commerce site in such a way that the social commerce site may use a payment, service, such as PayPal. For example, when purchasing an item, a social network user may wish to provide payment through a payment service. The social commerce site may prompt the social network user for payment information, communicate with the payment service, and complete the purchase while keeping the user within the social network environment.

The messaging application dashboard may allow a user to post a message generated outside of a social network environment within the social network environment. This may be done, for example, to allow a user to post messages to social network users, customers and prospective leads. For example, a user may identify a site within the social networking environment to be used to post the message. The messaging application dashboard may then use a wizard-driven message builder to assist the user in building a message. The message application dashboard may then instruct the messaging module to post the message to the site within the social network environment.

In one example embodiment, the message may be posted to the wall of a site within the social network. When using the messaging application dashboard, a user may see a list of all the posts created via the dashboard. The user may have the ability to edit an existing post or create a new post. To create a new wall post, the user may click the “Add New” button to create a new message that the user would like to post on the social network site wall of customers, prospective leads, or both. The user may then select or de-select prospective leads and customers that may receive the wall post message. The user may then click the “Send” button to deliver the message to the selected individuals.

The messaging application dashboard may allow a user to launch an email campaign wherein email addresses may be entered manually and/or may be imported from the social network environment or any third party source such as LinkedIn Contacts, Paid Mailing Lists, Outlook Contact List, Plaxo Contact List, or the like. For example, the user may identify a site within the social networking environment to be used in association with the message. The messaging application dashboard may then use an enhanced messaging builder to assist the user in creating an email message. The enhanced messaging builder may import email address from the third party source and/or the social network environment. The message application dashboard may then instruct the messaging module to post the message via the social network environment, or via email.

The messaging module may also track the messages sent to the social network users, customers, and prospective leads. The messaging module may provide a user with graphical or table view of number of messages sent from fanpage toolkit platform to the social network environment. The messages may include wall post messages or direct email messages.

The promotions dashboard may allow a user to generate promotions to be used for a site within a social network environment. This may be done, for example, to offer promotions and/or coupons to customers, prospective leads, or other social network users via the social network environment. The promotions dashboard may assist a user to track and manage promotions. Additionally, the promotions module may utilize the social media network to publicize promotions. For example, the promotions module may send out a FANvite to invite customers and fans to participate in an event, program or promotion.

In one example embodiment, the promotions dashboard may provide a user with a graphical or table view of the number of promotions, number of inactive promotions, number of promotion code users, social network user information, number of FANvites sent or the like. The promotions dashboard may also provide a user with a graphical or table view of the number of individuals that accept a FANvite, the number of individuals that decline a FANvite, the number of individuals that are unsure about a FANvite, and the number of individuals that have not replied.

In an example embodiment, the promotions dashboard may guide the user through the creation of a promotion. The user may select a social network site from a pull-down menu to create a new social network promotions page to engage and interact with social network users, such as fans. The user may then edit/preview an existing promotion or add a new promotion. The user may also have the ability to set all current promotions listed on this menu to “active”, “inactive” or archive.

To create a new promotion, the user may click the “Add New” button. The user may then select a template for a first layer, known as a call-to-action page. The user may then fill in the contents for selected promotions template. The user may then add a promotions name to identify it later in the dashboard. The user may also add content and images for the promotion. The user may also enter HTML code to customize the appearance of the promotion.

The user may customize and change the color, style and font for each section of the promotion. For example, the user may mouse over each section of the promotion anatomy to activate the hover edit menu. Editing options may be displayed via this menu.

The user may also create a second layer, known as a reveal page. The reveal page may be displayed once the social network user engages the promotions and executes the promotion code. The second layer may be designed, edited, and customized as described above with regard to the first layer. Once a promotion design is complete, start and end dates for the promotion may be added. This may provide the user with the ability to have different promotions run every day of the week.

The promotions application dashboard also serves to generate and manage sweepstakes, polls and digital downloads as mentioned above with respect to the promotions module.

The social commerce dashboard may allow a user to generate a social commerce site within a social network environment. This may be done, for example, to generate a social commerce site that social network users may use to make and complete purchases without leaving the social network environment. The social commerce application dashboard may also provide a user with a graphical or table view of the status of orders. For example, the user may view the number of completed orders, the number of orders in progress, or the number of canceled orders.

The social commerce dashboard may be used to allow a user to map their payment service credentials to the fanpage toolkit platform and/or a social commerce site. For example, using the social commerce dashboard a user may click on a merchant profile tab. The user may then see a menu that gives the user the option of adding a new profile, editing an existing profile, or deleting an existing profile. To add a new profile, the user may click the “Add New” button. The user may then provide payment service credentials to the social commerce dashboard. For example, the user may provide PayPal API credentials. Additionally, the user may specify shipping charges. For example, the user may enter in the types of shipping that the user wishes to support, the delivery period, and the shipping cost.

The social commerce dashboard may be used to create categories for the social commerce site that hold the products being sold. For example, the user may create different categories and sub-categories of products. For example, a user may create the sub-category “Gifts” under the category “Mother's Day.” To create categories, the user may click on the category tab. The user may then see a menu that gives you the option of adding new category, editing an existing category, or deleting an existing category.

To add a new category, the user may click the “Add New” button. The user may then select a site from the social network environment. The user may then enter the name of category the user wishes to create and may select the parent category. If the new category is not a sub-category, then the user may choose not to select a parent category.

The social commerce dashboard may be used to add new products to an existing or a new social commerce site. For example, a user may select product categories and other pertinent information such as price, pictures, features, availability, or the like to be submitted to the social commerce site. In one example embodiment, a user may click on a products tab within the social commerce dashboard. The user may then see a menu that gives the user the option of adding a new product, editing an existing product, or deleting an existing product.

To add a new Product, click the “Add New” button, the user may select a social network site. The user may then select a category you wish to place your product in and may provide a name for the product. The user may also enter a short description for the product. The user may also select to display the product on the main page of the social commerce site by identifying the product as a popular product. The user may then enter the selling price for the product and pictures for the product.

The social commerce dashboard may be also be used by a user to customize templates that may be used by the social commerce site. For example, a user may click on the templates tab in the social commerce dashboard. The user may then see a menu that gives the user the option of adding templates, editing existing templates, or deleting existing templates.

To add a new template, a user may click the “Add New” button. The user may then select one of the predesigned template designs. The user may then fill contents into the selected template. The user may then assign a name to the template being created. This may identify the template from other templates. The user may then customize the template by changing the colors, styles and fonts.

The social commerce dashboard may also allow a user to manage orders such that a user may track and manage all transactions that take place within a social commerce site. For example, a user may use the social commerce dashboard to fulfill an order by clicking on a view order icon in the dashboard. The user may then see customer order information. Shipping may also be fulfilled through the social commerce dashboard, for example, by checking off the shipping checkbox, entering the shipper carrier name, entering shipping tracking number, and entering shipping date.

The social commerce dashboard may also have a catalog feature for adding a new catalog, selecting a merchant profile. A user can set up a facebook store, either totally from scratch, or by going through the fanpage toolkit catalog in the social commerce dashboard and module. If the user already has an e-commerce store, and uses, for example Shopify or Zen Card or OS Commerce, and the other commercially available off-the-shelf programs for setting up an e-commerce store, the user can implement the data feed option in the catalog option in the social commerce application to allow the user to import its existing e-commerce store's product catalog and database into the fanpage toolkit platform. The social commerce module includes the ability to import from and interface with eBay and Magento systems and other open source or commercial e-commerce systems. The data feed option in the social commerce application allows the user to browse for the data, export the product catalog to a CSV or similar file format, enter the fanpage toolkit platform and select a new catalog, choose a merchant profile, choose a catalog type and/or use datafeed, to import any pre-existing catalog file and save it so as to operate through the fanpage toolkit platform. Such systems are synced so as to provide real time data. Thus, a purchase made on the user's existing catalog merchant page would sync and be real-time available to the fanpage social commerce customized catalog and page.

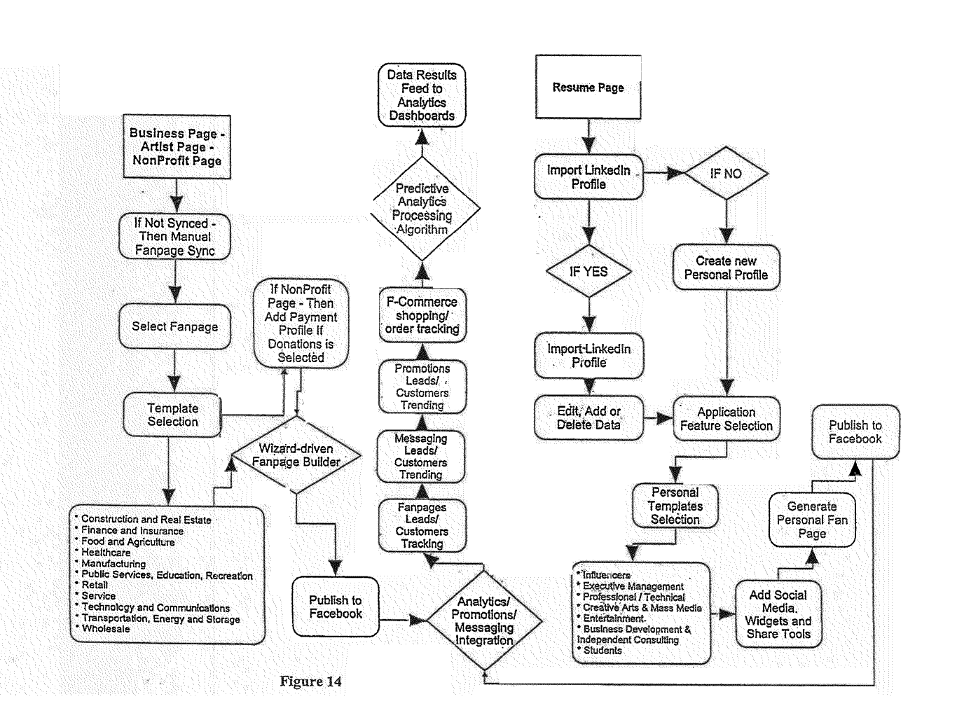

FIG. 14 illustrates an example embodiment of a method for generating a customized site within a social network environment. This may be done, for example, to generate a social commerce site that social network users may use to make and complete purchases without leaving the social network environment.

To generate a customized site within the social network environment, a user may log into the fanpage toolkit platform. The user may select a vertical. The verticals may define who the user is. For example, a vertical may be a business, a company, an organization, an institution, a brand, a product, an artist, a band, a politician, a college student, a job seeker, or the like. The user may then select the option to synchronize social network sites, such as fanpage sites, between the fanpage toolkit platform and the social network environment. This may be done, to ensure that the platform has access to all of the social network sites that belong to the user. The user may then select a social network site that may be used to generate the customized site. The user may then select a template to be used to design the customized site. The user may then generate the customized site using a wizard-driven builder and may publish the customized site a social network environment, such as Facebook.

In another example embodiment, the user may generate a customized site for finding employment. For example, the user may use the fanpage toolkit to modify a personal profile page. To modify the personal profile page, the fanpage toolkit platform may first determine whether the user has a user profile page, such as a LinkedIn profile page. If the user does not have a personal profile page, the platform may generate a new personal profile page within the social networking environment. If the user does have a personal profile page, the platform may import the personal profile page. The user may then edit, add, or delete data from the personal profile page. The platform may then provide the user with a number of features that may be added to the personal profile page. The user may then select a feature and a template to implement the feature. The platform may then add social media widgets and share tools, generate the customized site, and publish the site to the social network environment.

In another example embodiment, the fanpage toolkit may gather social network data regarding the customized sites created by a user. The fanpage tool kit may perform prospective lead and/or customer tracking. The fanpage tool kit may analyze the social media data for messages that may have been transmitted or received. The fanpage tool kit may analyze the social media data in order to track any promotions created by the user. The fanpage toolkit may also analyze the social media data to determine if any orders have occurred. Upon analyzing the social media data, the fanpage platform toolkit may then display the analysis and findings to the user through the dashboard described with respect to FIGS. 13A-B.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A computer-implemented method for providing analytic data for a site belonging to a social network environment, the method comprising:
receiving an identity of the site belonging to the social network environment;
retrieving social network data related to the site from within the social network environment;
generating analytic data from the retrieved social network data, the analytic data indicating social network user interactions with the site and including a prospective lead; and
providing the analytic data to an analytics user.

2. The method of claim 1, wherein generating analytic data comprises:
generating a list of social network users that have interacted with the site;
comparing the list of social network users to a customer database, the customer database including information regarding customers of the analytics user; and
identifying customers within the list of social network users.

3. The method of claim 1, wherein generating analytic data comprises:
generating a list of social network users that have interacted with the site;
comparing the list of social network users to a customer database, the customer database including information regarding customers of the analytics user; and
identifying the prospective lead from the list of social network users.

4. The method of claim 1, wherein generating analytic data comprises:
generating a list of social network users that have interacted with the site;
removing known customers from the list of social network users; and
identifying at least one of the remaining social network users in the list of social network users as the prospective lead.

5. The method of claim 1, wherein generating analytic data comprises:
identifying a product viewed by a social network user;
determining whether the product was purchased by the social network user; and
identifying the social network user as the prospective lead when the product was not purchased by the social network user.

6. The method of claim 1, wherein generating analytic data comprises:
determining a number of views, the number of views indicating a number of times that a social network user viewed a product; and
identifying the social network user as the prospective lead when the number of views exceeds a threshold.

7. The method of claim 1, wherein generating analytic data comprises:
determining a view time duration, the view time duration indicating a length of time that a social network user viewed a product;
identifying the social network user as the prospective lead when the view time duration exceeds a threshold.

8. The method of claim 1, wherein generating analytic data comprises:
analyzing a shopping cart linked to the site;
determining a social network user that placed a product in the shopping cart; and
identifying the social network user as the prospective lead.

9. The method of claim 1, further comprising geo-mapping the analytic data.

10. The method of claim 9, wherein geo-mapping the analytic data comprises:
determining a geographic location for each social network user within the social network data; and
for each social network user, associating the analytic data for with the geographic location for the social network user.

11. The method of claim 1, further comprising determining a keyword tag by analyzing the retrieved social network data.

12. The method of claim 11, wherein determining the keyword tag comprises:
retrieving social network user conversations from the retrieved social network data;
ranking words in the social network user conversations; and
generating the keyword tag based on the ranked words.

13. A computer-implemented method for generating a customized site within a social network environment, the method comprising:
retrieving social networking site information from a social network environment, the social networking site information defining the appearance of the site within the social network environment;
receiving a template selection from a user, the template defining customizations to be made to the site;
receiving site content from a user;
generating the customized site using the template selection and the site content; and
publishing the customized site to the social network environment.

14. The method of claim 13, further comprising receiving an identity of the site belonging to the social network environment from a user.

15. The method of claim 13, further comprising:
identifying the social network environment;
determining one or more templates that are compatible with the social network environment; and
presenting the one or more compatible templates to the user.

16. The method of claim 13, further comprising installing a social network application capable of executing within the social network environment and providing support for the customized site.

17. The method of claim 16, wherein publishing the customized site comprises transmitting executable instructions to the social network application to publish the customized site.

18. A computer-implemented method for messaging prospective leads within a social network environment, the method comprising:
retrieving social network data related to a site from within the social network environment;
determining a prospective lead from the social network data;
receiving message content from a user;
generating a message capable of being delivered within the social network environment in accordance with the received message content; and
transmitting the message to the prospective lead from within the social network environment.

19. The method of claim 18, wherein determining the prospective lead comprises:
generating a list of social network users that have interacted with the site from the social network data; and
identifying the prospective lead from the list of social network users.

20. The method of claim 18, wherein determining the prospective lead comprises:
generating a list of social network users that have interacted with the site;
removing known customers from the list of social network users; and
identifying a remaining social network user from the list of social network users as the prospective lead.

21. The method of claim 18, wherein determining the prospective lead comprises:
identifying a product viewed by a social network user;
determining whether the product was purchased by the social network user; and
identifying the social network user as the prospective lead when the product was not purchased by the social network user.

22. The method of claim 18, wherein determining the prospective lead comprises:
determining a number of views, the number of views indicating the number of times that a social network user viewed a product; and
identifying the social network user as the prospective lead when the number of views exceeds a threshold.

23. The method of claim 18, wherein determining the prospective lead comprises:
determining a view time duration, the view time duration indicating a length of time that a social network user viewed a product; and
identifying the social network user as the prospective lead when the view time duration exceeds a threshold.

24. A computer-implemented method for generating promotions to be used for a site within a social network environment, the method comprising:
retrieving social network data related to a site from within the social network environment;
generating a promotion code capable of being redeemed within the social network environment;
generating a promotion that includes the promotion code; and
transmitting the promotion to a social network user.

25. The method of claims 24, further comprising:
receiving a template selection from a user, the template defining a framework for the promotion; and
receiving content from the user.

26. The method of 24, wherein generating a promotion comprises:
generating a promotion having the appearance defined by the template; and
populating the promotion with the content and the promotion code

27. The method of claim 24, wherein transmitting the promotion to the social network user comprises displaying the promotion to the social network user within the social network environment.

28. The method of claim 24, wherein transmitting the promotion to the social network user comprises transmitting an invitation from within the social network environment to interact with the site within the social network environment.

29. A computer-implemented method for generating a social commerce site within a social network environment, the method comprising:
receiving a template selection from a seller, the template defining a framework for a site;
receiving site content from the seller;
generating a social commerce site capable of using a payment service within the social network environment to enable a social network user to purchase an item without leaving the social network environment;
modifying the social commerce site in accordance with the template and site content; and
publishing the social commerce site to the social network environment.

30. The method of claim 29, wherein generating a social commerce site comprises:
receiving credentials for the payment service from the seller; and
generating an electronic shopping cart able to access the payment service using the credentials from within the social network environment.

31. The method of claim 29, wherein generating the social commerce site comprises:
receiving the identity of the payment service from the seller;
determining an application interface compatible with the identified payment service; and
generating an electronic shopping cart to be used within the social network environment that is connected to the payment service.

32. The method of claim 29, wherein generating the social commerce site comprises:
receiving a product selection from the seller, the product selection indicating a product to be sold on the social commerce site; and
generating a social commerce site able to display and sell the product to a social network user from within the social network environment.

33. The method of claim 29, further comprising:
identifying the social network environment;
determining one or more templates that are compatible with the social network environment; and
presenting the one or more compatible templates to the seller.

34. The method of claim 29, further comprising installing a social network application capable of executing within the social network environment and providing support for the social commerce site.

35. The method of claim 34, wherein publishing the social commerce site comprises transmitting executable instructions to the social network application to display the social commerce site.

36. A system for providing analytic data for a site belonging to a social network environment, the system comprising:
a memory; and
a processor, the processor being configured to
receive an identity of the site belonging to the social network environment;
retrieve social network data related to the site from within the social network environment;
generate analytic data from the retrieved social network data, the analytic data indicating social network user interactions with the site and including a prospective lead; and
provide the analytic data to an analytics user.

37. A system for generating a customized site within a social network environment, the system comprising:
a memory; and,
a processor, the processor configured to
retrieve social networking site information from a social network environment, the social networking site information defining the appearance of the site within the social network environment;
receive a template selection from a user, the template defining customizations to be made to the site;
receive site content from a user;
generate the customized site using the template selection and the site content; and
publish the customized site to the social network environment.

38. A system for messaging prospective leads within a social network environment within the social network environment, the system comprising:
a memory; and
a processor, the processor being configured to:
retrieve social network data related to a site from within the social network environment;
determine a prospective lead from the social network data;
receive message content from a user;
generate a message capable of being delivered within the social network environment in accordance with the received message content; and
transmit the message to the prospective lead from within the social network environment.

39. A system for generating promotions to be used for a site within a social network environment, the system comprising:
a memory; and
a processor, the processor being configured to:
retrieve social network data related to a site from within the social network environment;
generate a promotion code capable of being redeemed within the social network environment;
generate a promotion that includes the promotion code; and
transmit the promotion to a social network user.

40. A system for generating a social commerce site within a social network environment, the system comprising:
a memory; and
a processor, the processor being configured to:
receive a template selection from a seller, the template defining a framework for a site;
receive site content from the seller;
generate a social commerce site capable of using a payment service within the social network environment to enable a social network user to purchase an item without leaving the social network environment;
modify the social commerce site in accordance with the template and site content; and
publish the social commerce site to the social network environment.
